(19) United States
(12) Patent Application Publication
(10) Pub. No.: US 2015/0379620 A1
(43) Pub. Date: Dec. 31, 2015

(54) METHODS AND SYSTEMS OF TRANSPARENCY BADGES IN E-COMMERCE

(71) Applicant: Sandeep Aggarwal, Fremont, CA (US)

(72) Inventor: Sandeep Aggarwal, Fremont, CA (US)

(21) Appl. No.: 14/724,785

(22) Filed: May 28, 2015

Related U.S. Application Data
(60) Provisional application No. 62/004,873, filed on May 29, 2014.

(51) Int. Cl. G06Q 30/06

(52) U.S. Cl. CPC G06Q 30/0641

(57) ABSTRACT

In one embodiment, a method include providing an online marketplace. The online marketplace implements a set of policies related to a seller behavior and a buyer behavior. A step includes determining a seller entity's metric with respect to the set of policies. A step includes determining a buyer entity's metric with respect to the set of policies. A step includes generating a seller's transparency badge. The seller's transparency badge comprises the seller entity's metric. A step includes generating a buyer's transparency badge. The seller's transparency badge comprises the buyer entity's metric.

### CROSS-REFERENCE TO RELATED APPLICATIONS

This application is a claims priority from U.S. Provisional Application No. 62004873, titled METHODS AND SYSTEMS OF TRANSPARENCY BADGES IN E-COMMERCE and filed 29 May 2014. This application is hereby incorporated by reference in its entirety.

### BACKGROUND

1. Field

This application relates generally to e-commerce, and more specifically to a system, article of manufacture and method for transparency badges in e-commerce.

2. Related Art

In an online marketplace, a buyer and/or a seller can enter into a transaction. When two parties are considering and/or implementing an e-commerce transaction, the transaction can suffer from information asymmetry and/or moral hazard issues. E-commerce transaction velocity can decrease. In an e-commerce environment establishing trust and/or transparency can longer. Trust and/or transparency can be key ingredients for a transaction to take place between a buyer and seller (and/or other parties in other types of e-commerce and/or physical transactions) in any e-commerce type setting such as, inter alia: information networks, physical retail, wholesale settings, or some other means such as phone, virtual reality, social media, video gaming platforms, etc. There is therefore a need and an opportunity to improve the methods and systems whereby transparency badges can be implemented to, inter alia, increase information symmetry between sellers and buyers in an e-commerce transaction.

### BRIEF SUMMARY OF THE INVENTION

In one embodiment, a method include providing an online marketplace. The online marketplace implements a set of policies related to a seller behavior and a buyer behavior. A step includes determining a seller entity's metric with respect to the set of policies. A step includes determining a buyer entity's metric with respect to the set of policies. A step includes generating a seller's transparency badge. The seller's transparency badge comprises the seller entity's metric. A step includes generating a buyer's transparency badge. The seller's transparency badge comprises the buyer entity's metric.

### BRIEF DESCRIPTION OF THE DRAWINGS

FIG. 1 depicts an example process of implementing transparency badges, according to some embodiments.

FIG. 2 illustrates an example process of generating and displaying transparency badges, according to some embodiments.

FIG. 3 depicts a process of using feedback, ratings and/or reviews from buyers and/or sellers to generate one or more transparency badges, according to some embodiments.

FIG. 4 illustrates, in block diagram format, an example e-commerce system, according to some embodiments.

FIG. 5 is a block diagram of a sample computing environment that can be utilized to implement various embodiments.

FIG. 6 depicts computing system with a number of components that may be used to perform any of the processes described herein.

The Figures described above are a representative set, and are not an exhaustive with respect to embodying the invention.

### DESCRIPTION

Disclosed are a system, method, and article of manufacture of computer-implemented transparency badges in e-commerce. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do riot necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may he practiced without one of more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided, to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may Of may not strictly adhere to the order of the corresponding steps shown.

### DEFINITIONS

Buyer can be an entity that purchases, rents, leases and/or otherwise obtains access to a good and/or item on an online-marketplace or other e-commerce system.

Data analytics can a process of inspecting, cleaning, transforming, and/or modeling data with the goal of discovering useful information, suggesting conclusions, and supporting decision making. Data analysis can include multiple facets and/or approaches, encompassing diverse techniques under a variety of names, in different business, science, and social science domains. Data analytics can include data mining (e.g. modeling and knowledge discovery for predictive rather than purely descriptive purposes). Data analytics can include various business intelligence methods (e.g. data analysis that uses aggregation, focusing on business information). Data analytics can use various statistical applications such as, inter alia: descriptive statistics, exploratory data analysis (EDA), and confirmatory data analysis (CDA). EDA can be used to discover new features in the data. CDA can confirm and/or falsify existing hypotheses. Data analytics can include predictive analytics that focus on the application of statistical and/or structural models for predictive forecasting or classification. Data analytics can include text analytics that applies statistical, linguistic, and/or structural techniques to extract and/or classify information from textual sources (and/or other species of unstructured data). These examples of Data analytics are provided by way of example and not of limitation. Other data analytics methodologies can be implemented in various example embodiments.

E-commerce can be trading in products or services conducted via computer networks such as the Internet. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web at least at one point in the transaction's life-cycle, although it may encompass a wider range of technologies such as e-mail, mobile devices, social media, and telephones as well.

Information asymmetry can refer to decisions in transactions where one party has more or better information than the other. This can create an imbalance of power in transactions which can cause the transactions to go awry, a kind of market failure in the worst case. Examples of this problem are adverse selection, moral hazard, and/or information monopoly.

Online marketplace can be a type of e-commerce site where product and inventory information can be provided by multiple third parties. In some examples, transactions can be processed by the marketplace operator. Online marketplaces can be a type of multichannel ecommerce. Amazon.com® can be an example of an online marketplace in some example embodiments.

Seller can be a provider of a good and/or service. Examples of a seller can be a merchant, service provider and/or any other party with a good and/or service available in the online-market place.

### EXAMPLE METHODS

A transparency system that can mitigate information asymmetry between a buyer and seller and reduce moral hazard so that transaction velocity can improve between buyer and seller. The transparency system can include a transparency badge. The transparency system and methodology can be applied to various aspects of an e-commerce transaction.

In one embodiment, a system and method can reduce information asymmetry by creating transparency badges in an online marketplace setting. Sellers can select an aspiration level for performance of certain tasks and/or deliverables. An online-market place entity (e.g. an entity that administers an online-market place) can capture and/or analyze seller data. The online-market place entity can display the actual performance of merchants against their selected aspiration level to potential buyers. For example, a seller can select a transparency badge that includes an assertion that any good the seller sells will be shipped within 48-hours. This assertion can be a level of aspiration. The online-market place entity then collects and/or analyzes the data on the seller's actual historical performance shows that he ships items within 48-hours only forty-eight percent (48%) of success rate. This information can then be displayed to potential buyers. Transparency badges are one example method of providing system transparency to a customer.

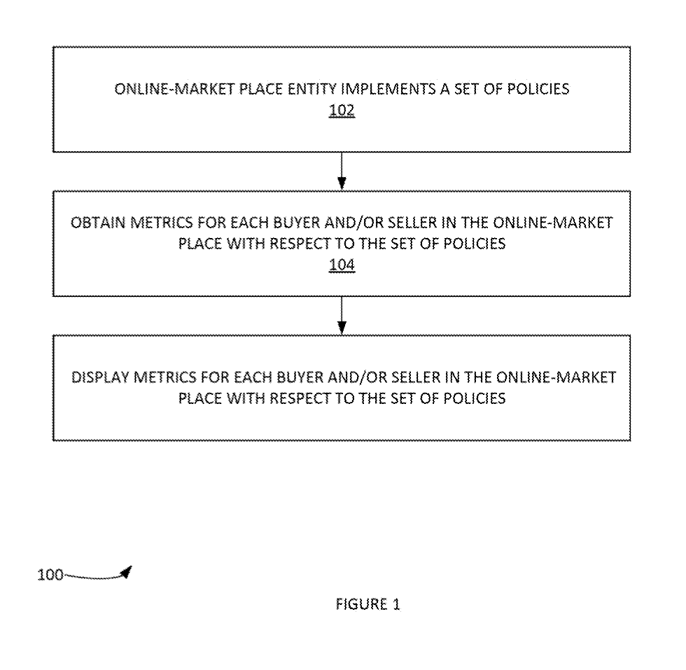

FIG. 1 depicts an example process 100 of implementing transparency badges, according to some embodiments. In step 102 of process 100, an online-market place can implement a set of policies. The policies can be related to various types of seller attributes and/or behavior (e.g. does seller mail goods within a specified time period, are seller's goods at a specified quality, etc.). The policies can be related to various types of buyer attributes and/or behavior (e.g. did buyer provide payment within a specified period, etc.). It is noted that, in some embodiments, a seller can select from multiple service levels within the set of policies. Examples of self-selected service levels are provided infra. The behavior of the various buyers and/or sellers can be obtained and analyzed. In step 104, the metrics for each buyer and/or seller can be obtained with respect to the online-market place policies. A set of metrics for each buyer and/or seller can be generated. The transparency badges can be generated in step 104. In step 106, the metrics for each buyer and/or seller can be displayed with respect to the online-market place policies. For example, an online-market place can set a policy that a purchased good should be mailed within a specified time period. A metric for each seller with respect to how often said seller meets the policy can be determined. The success frequency of the metric can be displayed (e.g. as a transparency badge on a web page, mobile device application, text message, etc.) with each other good and/or services offered by the seller.

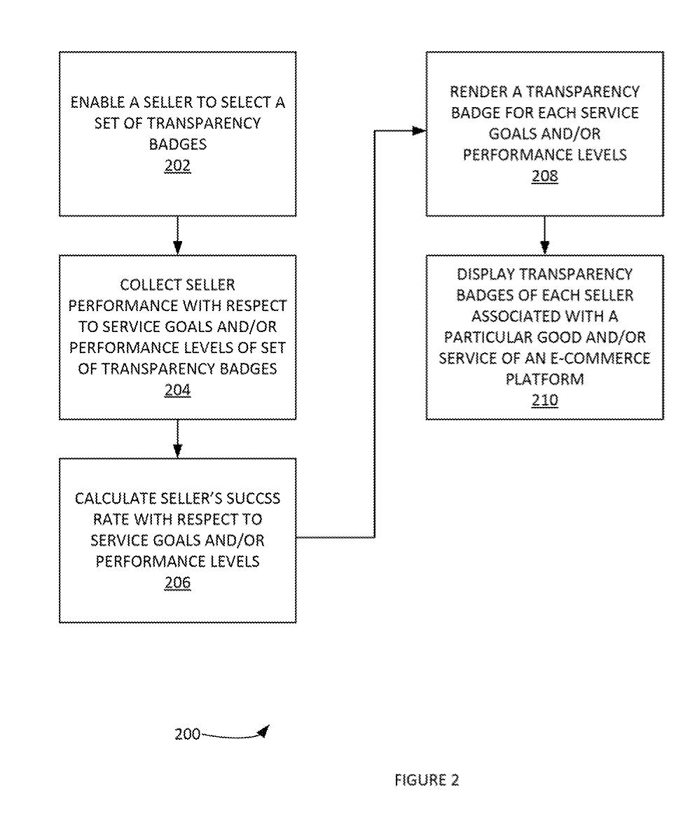

FIG. 2 illustrates an example process of generating and displaying transparency badges, according to some embodiments. In step 202 of process 200, a seller can be enabled to select a set of transparent badges. For example, the seller can select a transparency badge in terms of his/her likely service level or performance goals on certain goods and/or services (e.g. an aspirational, stretch and/or normal goal). These performance goals can be important to buyers. Various data analytics methodologies can be utilized to show, not only what seller has selected as aspirational goal, (e.g. in shape of a badge/icon) but also the seller's actual performance vis-à-vis the self-selected badge (e.g. actual achievement against aspirational goal). For example, in step 204, the seller's actual performance with respect to service goals and/or performance levels of a set of selected transparency badges can be collected. In step 206, the seller's success rate with respect to the service goals and/or performance levels can be calculated. In step 208, a transparency badge for each of the seller's service goals and/or performance levels can be rendered. It is noted that transparency badges can be associated with all the goods and/or services provided by a seller in some example embodiments. In other example embodiments, only the transparency badges selected for and/or relevant to a particular genre of goods and/or services or specific good and/or service may be rendered and displayed.

Process 200 can create an unparalleled transparency between a buyer and seller. Process 200 can reduces the information asymmetry often extant in online-marketplace transaction. For example, a buyer can make more informed decisions about a seller and his/her performance/service level agreements. Moreover, a seller can improve the gap between his/her aspirations and achievements. Seller can also have incentives not to suffer from moral hazard due to the increased transparency provided by process 200. In at least one embodiment, where process 200 is applied in online marketplace (e.g. information networks accessed by computing devices, electronic devices, mobile devices, virtual reality, social, gaming, etc.), it can significantly mitigate the risks associated with information asymmetry.

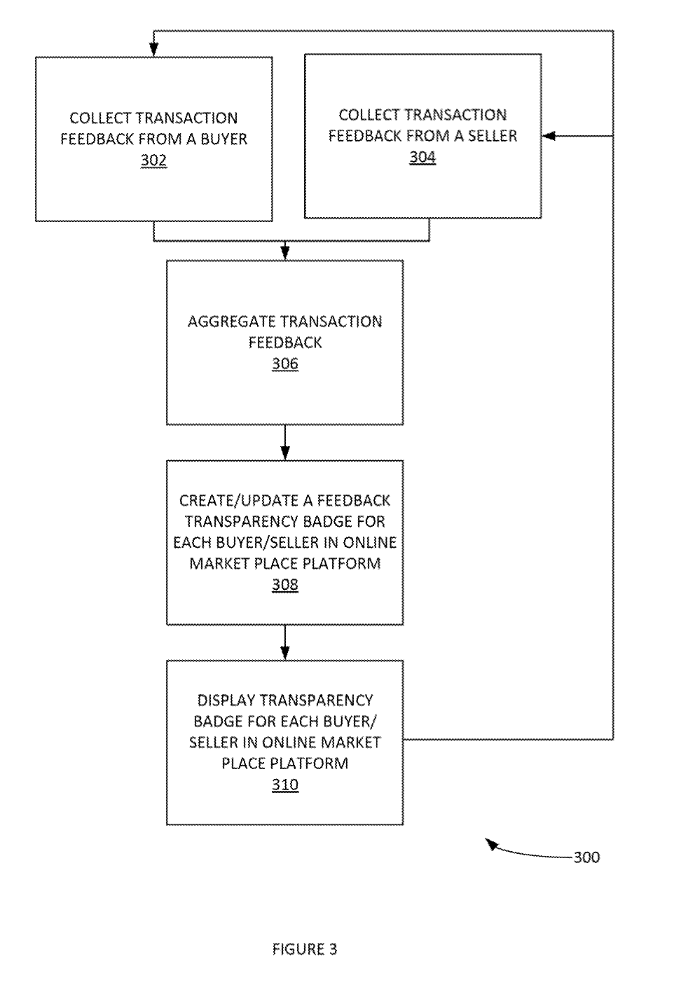

FIG. 3 depicts a process 300 of using feedback, ratings and/or reviews from buyers and/or sellers to generate one or more transparency badges, according to some embodiments. In one example, process 300 can enable unsatisfied buyers penalize sellers for poor performance. The transparency badges generated by process 300 can be rendered visible to other potential buyers of goods and/or services from the seller. Process 300 can also be used to rate buyers by unsatisfied sellers in some examples. In steps 302 and 304 of process 300, transaction feedback from buyers and/or sellers can be collected. In step 306, the transaction feedback can be aggregated. In step 308, a transparency badge for each users (e.g. each buyer, each seller, etc.) can be created based on the aggregated feedback of step 306 and/or the outputs of steps 302 and/or 304. In step 40, the transparency badge for each user can be displayed to other users of the online-market place platform. Process 300 can be repeated on as periodic and/or transactional basis. In this way, any user's transparency badge can be current (e.g. assuming system processes and networking latencies).

### EXAMPLE SYSTEMS AND ARCHITECTURE

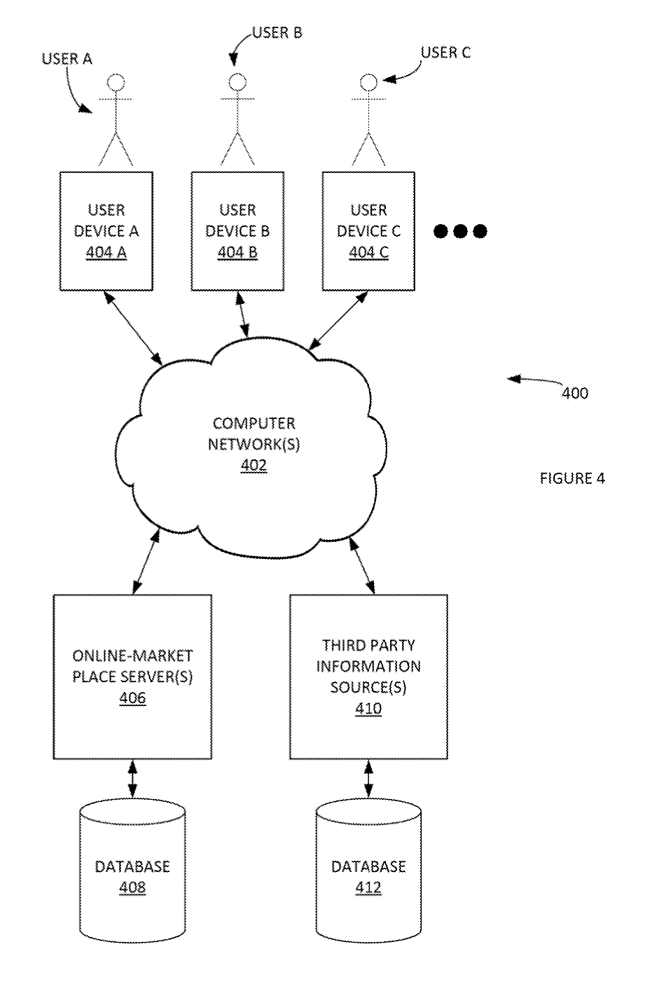

FIG. 4 illustrates, in block diagram format, an example e-commerce system 400, according to some embodiments. System 400 can include one or more computer network(s) 402 (e.g. the Internet, enterprise WAN, cellular data networks, etc.). User devices 404 A-C can include various functionalities (e.g. client-applications, web browsers, and the like) for interacting with an E-commerce server (e.g. e-commerce server(s) 406).

E-commerce server(s) 406 can provide and manage an e-commerce service (e.g. an online market place). In some embodiments, e-commerce server(s) 406 can be implemented in a cloud-computing environment. E-commerce server(s) 406 can include the functionalities provided herein, such those of FIGS. 1-3. E-commerce server(s) 406 can include web servers, database managers, functionalities for calling API's of relevant other systems, AI systems, data scrappers, natural language processing functionalities, ranking functionalities, statistical modelling and sampling functionalities, search engines, machine learning systems, Natural Language Processing Module, Recommendation Engine, text messaging modules (e.g. automatically generate SMS, MMS and other notifications to users), email modules (e.g. automatically generate email notifications to users), microblogging bots, user-feedback modules, transparency badge modules, etc. E-commerce server(s) 406 can implement various statistical and probabilistic algorithms to rank various elements of the e-commerce website (e.g. an online market place website). For example, e-commerce information in the database 408 (e.g. seller goals information, user profile information, seller attributes, transparency badge data, etc.) can be automatically sampled by the statistical algorithm. There are several methods which may be used to select a proper sample size and or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, 1. B. Carlin, H. S. Stern and D. B. Rubin, Chapman and Hall 1995; Chapter 7, where several sampling designs are discussed.

3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15,16,19 and 20, where population models are developed from acquired data samples.

4. Latent Dirichlet Allocation, Journal of Machine Learning Research 3 (2003) 993-1022, by David M. Blei, Computer Science Division, University of California, Berkeley, Calif. 94720, USA, Andrew Y. Ng, Computer Science Department, Stanford University, Stanford, Calif. 94305, USA.

It is noted that these statistical and probabilistic methodologies are for exemplary purposes and other statistical methodologies can be utilized and/or combined in various embodiments. These statistical methodologies can be utilized elsewhere, in whole or in part, when appropriate as well.

E-commerce server(s) 406 can include database 408. Database 408 can store data related to the functionalities of e-commerce server(s) 406. Third-party information server(s) 410 can be for such services as user-review verification systems, mailing services (e.g. can verify a seller sent a good at a specified date), and the like.

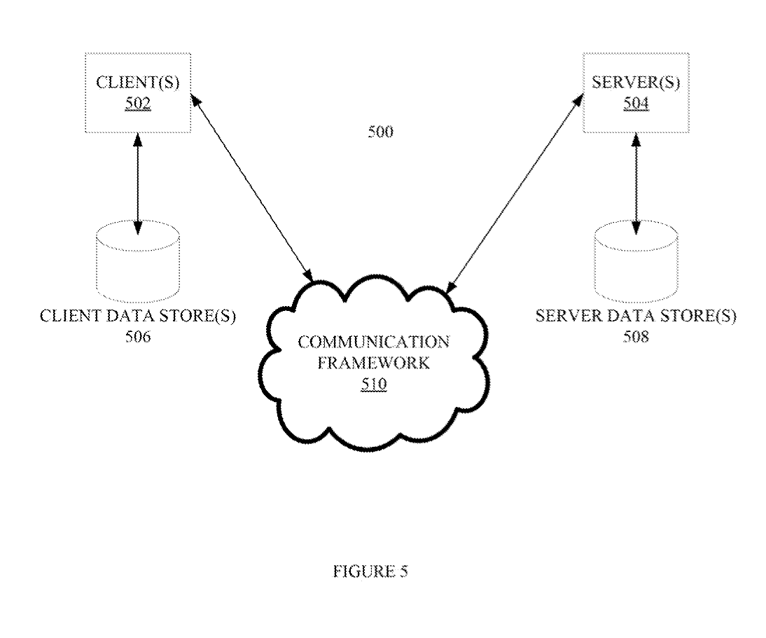

FIG. 5 is a block diagram of a sample computing, environment 500 that can be utilized to implement various embodiments. The system 500 further illustrates a system that includes one or more client(s) 502. The client(s) 502 can be hardware and/or software (e.g. threads, processes, computing devices). The system 500 also includes one or more server(s) 504. The server(s) 504 can also be hardware and/or software (e.g. threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information local to the server(s) 504.

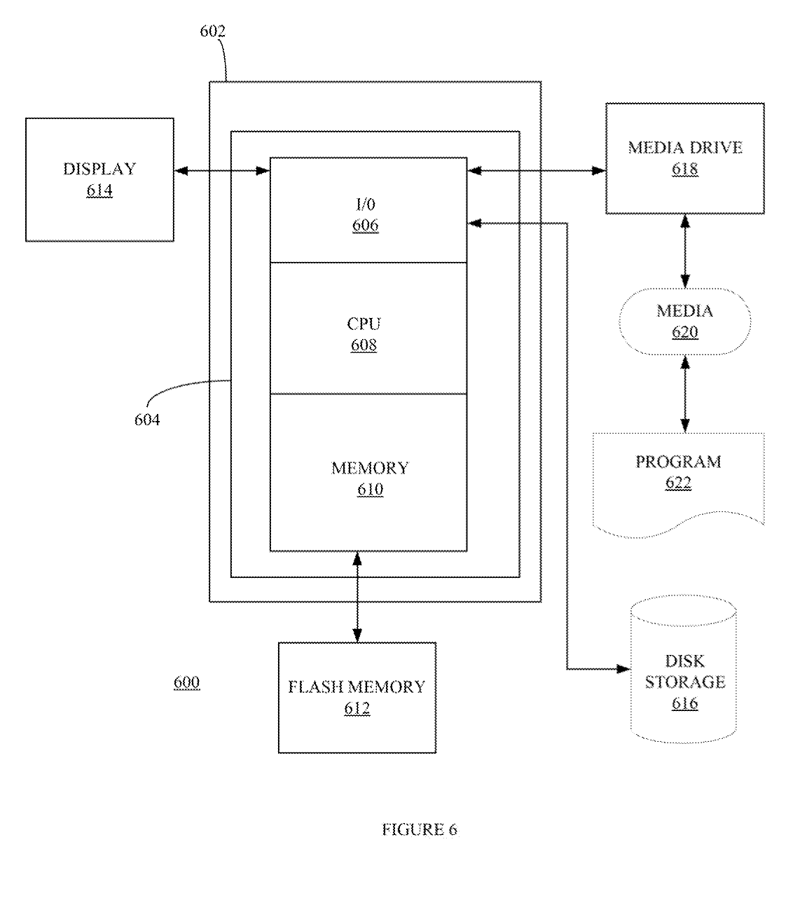

FIG. 6 depicts an exemplary computing system 600 that can be configured to perform any one of the processes provided herein. In this context, computing system 600 may include, for example, a processor, memory, storage, and I/O devices (e.g. monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can he configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Processes 100, 200, 300 and/or systems 400, 500 and 600 can be can be applied on various aspects of a transaction when buyers and sellers are likely to transact. These aspects can be pre, during and/or after a transaction has occurred and/or about to occur. Various examples are now provided by way of example and not of limitation.

A shipping time example is now provided. In an online marketplace (e.g. an information network where buyers and sellers attempt and/or transact with each other accessing the information networks via computing devices, electronic devices, mobile devices, virtual reality devices, social media and/or gaming platforms), buyers can perform a buying decision on many factors. One aspect of a transaction that may important for a buyer before implanting a transaction with a particular seller is how long will it take for the seller to ship the item once the buyer has placed the order. The delay between purchase of a good and shipping by the seller may important to the buyer. Accordingly, in the present example, the online marketplace can include a transparency badge system. For example, the seller (e.g. a merchant) can select a period before the good is shipped after the order is received. The example can include a self-disclosure service level that represents an aspirational goal for a seller. In another example, it can be based on an easy to achieve goal. It can be goal to attract more buyers or it may be just a genuine communication of actual performance. Once the seller has selected a specified service level or performance goal on self-selected basis, the data collection and analytics can show the seller's performance against his own self-selected disclosure. For example, the system can have five (5) badges for varied-service level for shipment time. These five levels can be: ships in twelve (12) hours, ships in twenty-four (24) hours, ships in thirty-six (36) hours, ships in forty-eight (48) hours and ships in seventy-two (72) hours. As the transparency badges have been selected by seller for a self-selected service level, the performance of the seller against that goal can be measured. The system can then determine the seller's actual service level and how has been this actual performance measures against the self-selected service level or goals. It is noted that in a conventional system, a buyer can leave negative feedback for the seller when seller does not ship item on item. However, the process of merely leaving negative feedback does not remove the information asymmetry whether a seller shipped the good on time.

A response rate for questions asked example is now provided. A buyer may wish to ask a seller a question. A transparency badge with respect to response rate can be associated with the seller. For example, the seller can select a specified response time for questions asked by buyers. The system can display the seller's actual performance against the self-selected service level.

A cancelation rate example is now provided. In an example online marketplace (e.g. an information network where buyers and sellers can enter into a transaction), a seller may sell a good is no longer available. This status may not be discovered until after order has been processed. The buyer can suffers from information asymmetry as to whether the seller will cancel the order after he receives an order. With transparency badges, information asymmetry can be mitigated. Accordingly, the system can monitor the seller's behavior with respect to cancellations and times to implement cancellations. The system can generate transparency badges that provide the seller's cancellation behavior attributes to the buyers.

A return decision example is now provided. In the event a buyer would like to return an item there may be uncertainty as to whether the seller will accept the return due to such factors as a non-standard return request etc. and/or return eligibility. In such an example, the buyer can experience information asymmetry in terms of time a seller may take to make a decision on a return. Moreover, the seller can experience a moral hazard in terms of not taking a decision on whether to accept a return or not on time. The system can provide transparency badges with respect to the sellers return decision attributes. For example, the seller can self-select a service level or goal in terms of time to provide a decision on a return of a good by the buyer. The buyer can access the seller's self-selected service level/goal, but also the seller's actual performance against his self-selected service level/goal (e.g. in the form of a transparency badge displayed to the buyer).

A refunds example is now provided. When a good is returned to a seller, the seller cam provide a refund to the buyer (e.g. full or partial refund, credit towards other purchases, etc.). The buyer may be concerned about the time will it take for the seller to perform the refund. Accordingly, the buyer can experience information asymmetry and seller can have a moral hazard issue in terms of not refunding for an item online. Accordingly, the system can monitor the seller's behavior with respect to refunds and times to implement refunds. The system can generate transparency badges that provide the seller's refund behavior attributes to the buyers.

### ADDITIONAL EXAMPLES

Additional example applications for transparency badges are now provided. In one example, a third party merchant or seller in an online e-commerce marketplace can disclose a few aspects of the items she is selling. This can be termed a ‘seller’ or ‘merchant declaration’. This declaration can be based on an honor code that a seller electronically signs. The declaration can state that the seller has been open, truthful and/or transparent in his seller/merchant declaration for the item(s) she is selling. The third party partner (e.g. a vendor, another team, verification service/auditor, etc.) can evaluate certain aspects and determine whether the seller/merchant declaration is passing or failing her behavior vis-à-vis the declaration's content. For example, a seller may be selling, a used vehicle and declare that the vehicle's air conditioner is in perfection condition and the car has accurate odometer reading. A third party inspection report vendor can concludes that the vehicle's air conditioner is not working and/or the odometer of the car has been tampered with. Accordingly, this independent inspection information can be included in the transparency badge. The transparency badge can be rendered for display in a web page and/or mobile application of the e-commerce marketplace.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method comprising:
providing an online marketplace, wherein the online marketplace implements a set of policies related to a seller behavior and a buyer behavior;
determining a seller entity's metric with respect to the set of policies;
determining a buyer entity's metric with respect to the set of policies;
generating a seller's transparency badge, wherein the seller's transparency badge comprises the seller entity's metric; and
generating a buyer's transparency badge, wherein the seller's transparency badge comprises the buyer entity's metric.

2. The method of claim 1, wherein a seller selects the seller transparency badge related a performance goal with respect to a good or a service provided by the seller on the online market place.

3. The method of claim 2, wherein the seller transparency badge comprises a seller's success rate with respect to the performance goal.

4. The method of claim 3, wherein a set of transparency badge is generated for each good or service that is provided by the seller on the online marketplace.

5. The method of claim 4, wherein the seller's transparency badge and the buyer's transparency badge comprise a graphical display element displayed on a web page or in a mobile application of the online marketplace.

6. The method of claim 5, wherein the transparency badge comprises a percentage of times that the seller mail goods within a specified time period.

7. The method of claim 6, wherein the transparency badge comprises a percentage of the seller's goods that are determined to be of a specified quality.

8. The method of claim 7,
wherein a customer of the seller's good or service can rate the seller, and
wherein the transparency badge can include one or more ratings of the customer.

9. A computerized-system comprising:
a processor configured to execute instructions;
a memory containing instructions when executed on the processor, causes the processor to perform operations that:
provide an online marketplace, wherein the online marketplace implements a set of policies related to a seller behavior and a buyer behavior;
determine a seller entity's metric with respect to the set of policies;
determine a buyer entity's metric with respect to the set of policies;
generate a seller's transparency badge, wherein the seller's transparency badge comprises the seller entity's metric; and
generate a buyer's transparency badge, wherein the seller's transparency badge comprises the buyer entity's metric.

10. The computerized-system of claim 9, wherein a seller selects the seller transparency badge related a performance goal with respect to a good or a service provided by the seller on the online market place.

11. The computerized-system of claim 10, wherein the seller transparency badge comprises a seller's success rate with respect to the performance goal.

12. The computerized-system of claim 11, wherein a set of transparency badge is generated for each good or service that is provided by the seller on the online marketplace.

13. The computerized-system of claim 12, wherein the seller's transparency badge and the buyer's transparency badge comprise a graphical display element displayed on a web page or in a mobile application of the online marketplace.

14. The computerized-system of claim 13, wherein the transparency badge comprises a percentage of times that the seller mail goods within a specified time period.

15. The computerized-system of claim 14, wherein the transparency badge comprises a percentage of the seller's goods that are determined to be of to specified quality.

16. The computerized-system of claim 15,
wherein a customer of the seller's good or service can rate the seller, and
wherein the transparency badge can include one or more ratings of the customer.
